(19) United States
(12) Patent Application Publication
(10) Pub. No.: US 2026/0281373 A1
(43) Pub. Date: Sep. 17, 2026

(54) METHODS AND APPARATUS OF DECODER-SIDE INTRA MODE DERIVATION AND PREDICTION WITH INFLUENCE OF HISTOGRAM OF GRADIENTS FROM THE NEIGHBOURHOOD IN VIDEO CODING

(71) Applicant: MEDIATEK INC., Hsinchu City (TW)

(72) Inventors: Hong-Hui CHEN, Hsinchu City (TW); Man-Shu CHIANG, Hsinchu City (TW); Hsin-Yi TSENG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW)

(21) Appl. No.: 19/472,685

(22) PCT Filed: Jul. 30, 2024
(86) PCT No.: PCT/CN2024/108512

§ 371 Date: Oct. 5, 2025

Related U.S. Application Data
(60) Provisional application No. 63/516,878, filed on Aug. 1, 2023.

(51) Int. Cl. H04N 19/14; H04N 19/105; H04N 19/176; H04N 19/423

(52) U.S. Cl. CPC H04N 19/14; H04N 19/105; H04N 19/176; H04N 19/423

(57) ABSTRACT

A method and apparatus for video coding by storing HoG of the current block for use by one or more subsequent blocks are disclosed. According to the method, input data associated with a current block is received, wherein the input data comprise pixel data to be encoded at an encoder side or data associated with the current block to be decoded at a decoder side. A HoG (Histogram of Gradients) associated with the current block is determined. The HoG is stored in a buffer. A subsequent block of the current block is encoded or decoded by using information comprising the HoG.

### CROSS REFERENCE TO RELATED APPLICATIONS

The present invention is a non-Provisional application of and claims priority to U.S. Provisional Patent Application No. 63/516,878, filed on Aug. 1, 2023. The U.S. Provisional patent application is hereby incorporated by reference in its entirety.

### FIELD OF THE INVENTION

The present invention relates to video coding system. In particular, the present invention relates to derivation and storage of HoG (Histogram of Gradients) associated with Decoder-Side Intra Mode Derivation (DIMD) for future block coding in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed and stored at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Decoder Side Intra Mode Derivation (DIMD)

When DIMD is applied, five intra modes are derived from the reconstructed neighbour samples, and those five predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, cantered on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

FIGS. 2A-C show an example of HoG, calculated after applying the above operations on all pixel positions in the template. FIG. 2A illustrates an example of selected template 220 for a current block 210. Template 220 comprises T lines above the current block and T columns to the left of the current block. For intra prediction of the current block, the area 230 at the above and left of the current block corresponds to a reconstructed area and the area 240 below and at the right of the block corresponds to an unavailable area. FIG. 2B illustrates an example for T=3 and the HoGs are calculated for pixels 260 in the middle line and pixels 262 in the middle column. For example, for pixel 252, a 3×3 window 250 is used. FIG. 2C illustrates an example of the amplitudes (ampl) calculated based on equation (2) for the angular intra prediction modes as determined from equation (1).

Once HoG is computed, the indices with five tallest histogram bars are selected as the five implicitly derived intra prediction modes for the block and are further combined with the Planar mode as the prediction of DIMD mode. Predictors from these six prediction modes are blended according to the derived weights (based on the amplitudes of the HoG) to form the final prediction of current CU.

In the present invention, we propose to store the HoG of the current block for use by subsequent blocks of the current block.

### BRIEF SUMMARY OF THE INVENTION

A method and apparatus for video coding by storing HoG of the current block for use by one or more subsequent blocks are disclosed. According to the method, input data associated with a current block is received, wherein the input data comprise pixel data to be encoded at an encoder side or data associated with the current block to be decoded at a decoder side. A HoG (Histogram of Gradients) associated with the current block is determined. The HoG is stored in a buffer. A subsequent block of the current block is encoded or decoded by using information comprising the HoG.

In one embodiment, the current block is encoded or decoded using current information comprising stored one or more HoGs from one or more neighbouring regions of the current block. In one embodiment, said one or more neighbouring regions of the current block comprise an above region, an above-left region, a left region, a bottom-left region, a bottom region, a bottom-right region, a right region, an above-right region, or a combination thereof.

In one embodiment, the HoG associated with the current block is available for the current block if the current block is DIMD (Decoder Side Intra Mode Derivation) coded, the current block is coded with one or more first angular modes overlapped with one or more second angular modes derived by the DIMD, or the current block is coded with DIMD inheritance mode.

In one embodiment, the HoG associated with the current block is inherited from one or more HoGs of one or more neighbouring regions. In one embodiment, said one or more neighbouring regions correspond to one or more above blocks and one or more left blocks. In one embodiment, bins of the HoG associated with the current block are derived by averaging corresponding bins of said one or more HoGs of said one or more neighbouring regions respectively. In another embodiment, bins of the HoG associated with the current block are derived by using a weighted sum of corresponding bins of said one or more HoGs of said one or more neighbouring regions respectively, and wherein weights for the weighted sum of the corresponding bins of said one or more HoGs of said one or more neighbouring regions are related to confidence factors of said one or more neighbouring regions. In one embodiment, a flag is signalled or parsed to indicate the HoG associated with the current block being inherited from said one or more HoGs of said one or more neighbouring regions.

In one embodiment, the HoG associated with the current block is inherited from one or more selected neighbouring regions. In one embodiment, said one or more selected neighbouring regions are from above region and left region, from the above region, above-left region, the left region and bottom-left region, from the left region only, or from the above region only. In one embodiment, one or more indexes are signalled or parsed to indicate said one or more selected neighbouring regions. In one embodiment, said one or more selected neighbouring regions are determined implicitly by using template matching and/or boundary matching. In one embodiment, validity check is applied to one or more neighbouring regions of the current block and an invalid neighbouring region is eliminated from said one or more selected neighbouring regions, and wherein the validity is determined according to a ratio a first number of boundary samples of the current block located in a CU having HoG values and a second number of boundary samples of an adjacent neighbouring region.

In one embodiment, two or more predictors associated with two or more intra modes derived from two or more regions of said one or more neighbouring regions of the current block are blended to form a final predictor for the current block. In one embodiment, said two or more predictors are blended using position-dependent weighting. In one embodiment, the position-dependent weighting is determined for one or more positions of said one or more neighbouring regions of the current block according to a total number of samples coded with DIMD mode in said one or more positions of said one or more neighbouring regions of the current block. In one embodiment, the position-dependent weighting is further dependent on sample position of the final predictor. In one embodiment, the current block is divided into multiple bands and the position-dependent weighting is dependent on band location of the sample position of the final predictor. In one embodiment, said two or more predictors are blended using position-independent weighting.

In one embodiment, when the current block is DIMD coded, a current HoG derived from the current block is blended with one or more HoGs from one or more neighbouring regions of the current block. In one embodiment, the current HoG and said one or more HoGs from said one or more neighbouring regions of the current block are blended using equal weight for both or only for said one or more HoGs from said one or more neighbouring regions of the current block. In one embodiment, the current HoG and said one or more HoGs from said one or more neighbouring regions of the current block are blended using weights and wherein the weights are inversely proportional to distance between current block and said one or more neighbouring regions of the current block. In one embodiment, the HoG associated with the current block is blended with one or more HoGs from one or more temporal regions. In one embodiment, the HoG associated with the current block is blended with said one or more HoGs from said one or more temporal regions using POC (Picture Order Count) distance dependent weight.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2A illustrates an example of selected template for a current block, where the template comprises T rows above the current block and T columns left the current block.

FIG. 2B illustrates an example for T=3 and the HoGs (Histogram of Gradient) are calculated for pixels in the middle row and pixels in the middle column.

FIG. 2C illustrates an example of the amplitudes (ampl) for the angular intra prediction modes.

FIG. 3 illustrates an example of neighbouring regions and related neighbouring CUs for building the HoG for the current block according to one embodiment of the present invention.

FIG. 4 illustrates an example for Dratio being 0.6 of the above side.

FIGS. 5A-C illustrate examples of position-dependent weights for predictor blending.

FIG. 6 illustrates a flowchart of an exemplary video coding system that stores the HoG of the current block for use by one or more subsequent blocks according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to improve the Decoder-side Intra Mode Derivation (DIMD) prediction accuracy and coding performance.

The original DIMD method adopts the adjacent L shape with thickness of 3 samples to build the histogram of gradients (HoG). In this invention, we further consider the already built HoGs from the neighbouring CUs for building the HoG for the current CU for deriving the intra modes. The neighbouring CUs can be from above region (A), left region (L), above-right region (AR), above-left region (AL) and bottom-left region (BL) as shown in FIG. 3. In FIG. 3, the neighbouring CUs are CU_A0, CU_A1, CU_A2, CU_ALC, CU_L0, CU_L1, CU_BLC, CU_B0, CU_B1, CU_B2, CU_BRC, CU_R0, and CU_ARC.

In the above region there are three CUs (i.e., CU_A0, CU_A1, CU_A2) adjacent to the current CU. The left region has two adjacent CUs. Regions AL and BL only have one CU adjacent to the current CU. These adjacent CUs can be encoded as intra CUs or inter CUs. In the following, several methods are disclosed to encode the current CU with extend methods based on DIMD.

### 1. HoG Storing in Buffer

For an I slice, all the neighbouring CUs are intra CUs. Some of them can be encoded with DIMD flag set true. For DIMD derivation process, a histogram of the gradients (HoG) is built to derive the intra modes for prediction blending. For the current DIMD method in Enhanced Compression Model (ECM) version 9 (Muhammed Coban, et al., “Algorithm description of Enhanced Compression Model 9 (ECM 9)”, Joint Video Exploration Team (JVET) of ITU-T SG 16 WP 3 and ISO/IEC JTC 1/SC 29/WG 11, 30th Meeting, Antalya, TR, 21-28 Apr. 2023, Document: JVET-AD2025), HoG is not stored for use by future CUs. In this method, an extra buffer for storing the HoG is allocated. HoG is stored according to following conditions:
C.1 A CU is coded with DIMD mode
C.2 A CU is not coded with DIMD mode, but encoded with angular intra mode with the angular intra mode having the highest HoG's amplitude
C.3 A CU is not coded with DIMD mode, but encoded with angular intra mode with the angular intra mode having the HoG's amplitude among the first K highest amplitudes
C.4 A CU is coded with angular intra mode
C.5 Always store the HoG of a CU

Conditions C1 to C3 can be applied individually. Otherwise, they can be applied jointly. For example, C.1 and C.2 can be used together as the condition for storing the HoG. Condition C.2 is a limited version of C.3 by setting the K to 1. For C.1, DIMD flag in picture-level coding structure can be used for deciding the availability of the stored HoG. For C.2 or C.3, an extra flag is required for checking the available of the HoG.

For the current DIMD algorithm, the HoG is composed of 67 bins for all possible angular intra modes. In one embodiment, all the bins of HoG are stored. However, to store all the bins of HoG imposes a high buffer storage requirement. Therefore, in another embodiment, only M bins with the highest amplitudes are stored. For example, M can be 10. Otherwise, bins of HoG can be combined first before storing. For example, intra modes from 2 to 5 can be summed and shifted right by S bits, where S can be zero for no shift. For this example, S can be 2 for restoring the value range after summing the bins together. The stored HoGs are used in the coding methods proposed in the following sections.

### 2. Pure DIMD Inheritance Mode

With the availability of neighbouring HoGs when encoding the current CU, the neighbouring HoGs can be used to build an inherited HoG for the current CU. There is no need to calculate the gradients of the L shape of the current CU and only use the bins from the stored neighbouring HoGs to compose a HoG for the current CU. The HoG for the current CU can be constructed by averaging the neighbouring HoGs for some embodiments. For other embodiments, weighted averaging of the HoGs can be used. The weight of a certain HoG is proportional to a confidence factor of the neighbouring CU. The higher the confidence factor is, the higher weight is assigned. The following formula shows the weighted averaging for HoGs from the above and left sides (assuming only above and left side CUs with valid HoGs) of FIG. 3:

$$BinCurrentCU [ K ] = \{ CF 0 * BinCU\_A0 [ K ] + CF 1 * BinCU\_A1 [ K ] + CF 2 * BinCU\_A2 [ K ] + CF 3 * BinCU\_L0 [ K ] + CF 4 * BinCU\_L1 [ K ] \} / \{ CF 0 + CF 01 + CF 02 + CF 03 + CF 04 \} ,$$

where CF represents confidence factor and K represents a bin index.

For one embodiment, the confidence factor can be related to whether the neighbouring CU is intra coded or not. In one embodiment, if the CU used to build the neighbouring HoG is intra coded, multiplying a factor greater than one and/or adding an offset greater than zero to the weight can be utilized. In another embodiment, if the CU used to build the neighbouring HoG is inter coded, multiplying a factor smaller than one and/or adding an offset less than zero to the weight can be utilized. In another embodiment, intra coded neighbouring CU with confidence factor set to 3 for its bins of HoG and inter coded neighbouring CU with confidence factor set to 1 for its bins of HoG. In another embodiment, the statistics of bin values of the HoG is used as the confidence factor. For example, higher confidence factor can be set to the HoG where bin values are with a small standard deviation.

After building the HoG for the current CU, the remaining steps of DIMD procedure can be applied for identifying intra modes with high accumulated gradient values for prediction blending operation. CU with this inherited HoGs is considered as a sub-mode DIMD and an extra flag as an explicit syntax element is used for specifying the usage of this sub-mode if the extra flag is set to true. In another embodiment, if the number of available neighbouring HoG is larger than a threshold T1 and/or the percentage of the neighbouring CU with available HoG is larger than a threshold T2, this DIMD sub-mode is inferred to be used directly without extra signalling.

3. Neighbouring HoG from CU Encoded by DIMD with or without Sub-Mode (Inherited HoG):

With the added sub-mode of DIMD by inheriting the HoG from neighbouring CUs. The condition C.1 from the previous section can be extended. For one embodiment, the valid neighbouring HoG comes from the CU coded with DIMD with sub-mode (inherited HoG) and CU coded without sub-mode (i.e., the original DIMD coding flow) turned on.

4. HoG Inheritance with Selected Regions

Inheritance of the HoG can be applied from all the allowable regions or only from selected regions. The possible combinations of the regions are:
R.1 From above and left regions
R.2 From above, above-left, left and bottom-left regions
R.3 From above region only
R.4 From left region only

For one embodiment, HoG inheritance from R.2, R.3, and R.4 are used jointly to derive three group of intra modes. An explicit syntax as an index (e.g. 0: R.2, 1: R.3, 2: R.4) to select the final region used (normally through RDO process). For another embodiment, a validation process is first applied to the region. A threshold Tr0 for the following attribute Dratio is checked for some regions to become valid. Dratio can be determined based on N and D, where N is number of samples for one side (e.g. above side or left side) and D is the number of samples associated with a CU with valid HoG stored in the HoG buffer.

$$Dratio = D / N .$$

One example of Dratio=0.6 for above side is shown in FIG. 4, where the grey circles correspond to samples on the above side of the current block and the white circles correspond to boundary samples of an adjacent region. Furthermore, the white circles with numbers correspond samples with valid HoG and the white circles with an “X” correspond samples located in a CU without a valid HoG.

If Dratio>=Tr0, the side is valid, and R.3 and R.4 can be viewed as valid for HoG inheritance. R.2 is regarded as always valid. When some of the region is invalid, the index can change its meaning. For example, if only R.2 and R.4 are valid, index 0 is for R.2 and index 1 is for R.4. If R.3 and R.4 are all invalid, then no need to signal the index and only R.2 is used for the HoG inheritance.

In another embodiment, a threshold Tr1 is used for R.2 for the validity check. Tr0 and Tr1 can be set to the same value or different values. If Tr0 and Tr1 are always the same, only one threshold is needed. After validity check, there may be partial regions available, such as R.3 and R.4 and the index meaning of the signalled index is changed accordingly. In one extreme case, all the regions are invalid. For this situation, the CU cannot be encoded with DIMD mode with inherited HoGs. In another embodiment, TM (Template Matching) costs or boundary matching costs are calculated with the intra modes derived from different regions. Then final intra mode are selected with the lowest cost and no extra syntax element is signalled.

### 5. Position-Dependent Weighting for Combining Predictions

In addition to selecting a specific region for adopting its derived intra modes for prediction, it is possible to keep all the intra mode candidates from multiple regions and generate blended predictions from all the intra modes. For example, intra modes from R.2, R.3 and R.4 are used to generate their predictions. Because single prediction is required to encode the CU, predictions from R.2, R.3 and R.4 can be blended to form the final prediction. We derive a confidence level for all the size and for the L-shape as follows:

$$Conference level for L - shape = Number of above and left reconstructed pixels coded with DIMD / ( width + height ) \qquad CF \text{.1}$$

$$Conference level for above side = Number of above reconstructed pixels coded with DIMD / width \qquad CF \text{.2}$$

$$Conference level for left side = Number of left reconstructed pixels coded with DIMD / height \qquad CF \text{.3}$$

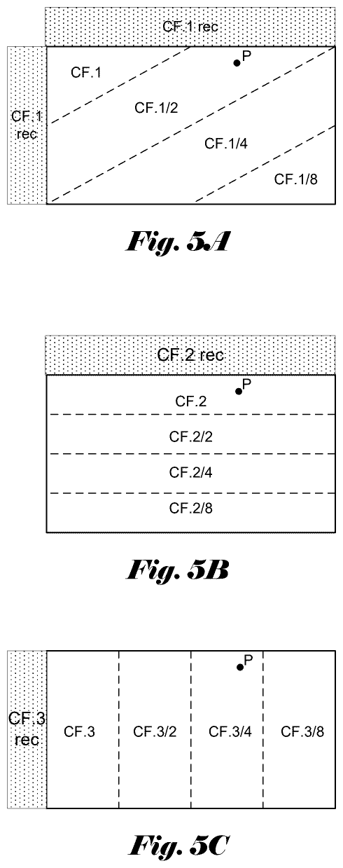

These confidence level can be further modified according to the sample position of the CU when prediction blending is conducted. FIG. 5 shows an example of position-dependent weights derived from the confidence level. As shown in FIG. 5, the sample positions are divided into 4 bands and each band uses a specific weight. When both left and above regions are used, the bands are formed using diagonal partition lines. When only the above region is used, the 4 bands are formed by using horizontal partitioning lines. When only the left region is used, the 4 bands are formed by using vertical partitioning lines. Furthermore, weights shown in FIG. 5 have larger values for bands closer to the neighbouring region(s). While the weight ratios correspond to 1, 1/2, 1/4, and 1/8 in this example, other weight rations can also be used.

The blended value of sample P in FIG. 5 can be calculated by the following formula:

$$P = ( P 0 * CF \text{.1} / 2 + P 1 * CF \text{.2} + P 2 * CF \text{.3} / 4 ) / ( CF \text{.1} / 2 + CF \text{.2} + CF \text{.3} / 4 ) .$$

6. HoG Blending with Current CU's HoG:

In pure DIMD inheritance mode, only neighbouring HoGs are used for generating the HoG for the current CU. In the proposed method in this section, we further adopt the HoG of the current CU for coding. HoG for the current CU is built with the original DIMD procedure. Then mixing the HoGs from neighbours and the HoG of current CU with certain weights to build the final mixed HoG. In another embodiment, the neighbours which derive the neighbouring HoGs, are only from the selected regions specified in the section “HoG Inheritance with Selected Regions.” Methods for deciding the weights can be as follows:
M.1 Equal weights for each HoG
M.2 Weights related to statistics of CU, where the HoG is derived (for example: standard deviation of the bin values)
M.3 Like M.1, equal weights for each neighbouring HoG with an additional weight for the HoG of current CU
M.4 Like M.2, weights related to statistics of CU where the HoG is derived. An additional weight for the HoG of current CU.
M.5 Weights related to the distance between the neighbouring CU (where the neighbouring HoG is derived) and the current CU. For example, if one neighbouring HoG is derived by the first neighbouring CU far away from the current CU, the weight for the one will be smaller than the weight for another neighbouring HoG which is derived by the second neighbouring CU near the current CU.

In one embodiment of M.5, the distance between two CUs can be the distance between the centre positions of the two CUs. In another embodiment, the distance between two CUs can be the shortest distance between the 4 possible choices of the corners of the first CU and the 4 possible choices of the corners of the second CU. The distance is normally calculated by the following formula:

$$Distance between two CUs = square root of ( {( {X}_{0} - {X}_{1} )}^{2} + {( {Y}_{1} - {Y}_{2} )}^{2} ) .$$

In another embodiment, the distance can be the difference between one of the coordinates with smaller difference. For example, the distance is the smaller one from absolute value of (X₀−X₁) and absolute value of (Y₀−Y₁).

The sum of the weights for M.1 to M.5, or the sum of the weights for any subset of M1 to M5 is used as the denominator for normalizing the mixed amplitudes of the bins of the HoG. The normalization process is required for keeping the numerical range of the amplitudes of the HoG. After the mixed HoG is built, the remaining procedure of the DIMD is conducted.

### 7. Adoption of Temporal Regions' HoGs:

In FIG. 3, HoG of regions R, B, and BR can also be available when coding in a non-I slice by referring to reference frames. In addition to acquiring the HoG from regions A, AL, L, and BL, the collocated areas of reference frames in list 0 or list 1 can have CU coded with DIMD mode (with or without inherited HoG). For example, CU_R0, CU_B0, CU_B1, CU_B2, and CU_BRC can have their associated HoGs stored in the HoG buffer. Therefore, these HoG can be utilized with the same procedure mentioned in previous sections. For instance, HoG validation, HoG weight assignment and HoG mixing can be done with these HoGs from reference frames. For each reference frame to have their own HoG buffer, extra storage is required, and the amount of storage is proportional to the maximal number of reference frames. In another embodiment, if CU used to build the neighbouring HoG is from reference frames, an extra weight assigned to the blending the HoG is assigned. In another embodiment, if the CU used to build the neighbouring HoG is from reference frames, an extra weight derived from the POC distance for the blending the HoG is utilized.

### 8. HoG Propagation for DIMD Intra Coding in Non-I Slice

For an I slice, the DIMD process is conducted, and HoGs of the CUs are stored in the HoG buffer. Normally only the CU coded with DIMD can have its non-inherited HoG or inherited HoG stored to be used for the inter coding slice as the HoG inheritance source described in the previous section. We further propose a HoG propagation mode. When coding the CU not coded with intra modes in an inter slice, the HoG can be retrieved from the HoG buffer through motion vector (MV) or block vector (BV) for updating the HoG buffer with the retrieved HoG. With the HoG inferred by MV or BV, HoG is propagated through the guiding information. The propagation process can be done through several non-I slice frames and keep filling the HoG buffer with MV or BV guided HoG update. Therefore, it is easier for a CU in non-I slice to find valid neighbouring HoGs for pure DIMD inheritance mode or DIMD HoG blending mode. Compared to the previous section with the HoG coming from reference frames, the HoG storage requirement for propagation mode is constrained. For one implementation, single HoG buffer can be utilized. The MV or BV is utilized to refer the HoG and read the HoG, then write to the HoG buffer portion of the current CU. Therefore, after coding of the current CU, the HoG buffer for propagation has been updated with latest HoG context.

9. Multiple Filters with Implicit Selection of Pre-Filters and Gradient Extraction Filter Pairs

HoG for DIMD coding mode is derived by using a pair of Sobel filters to generate the gradients. The Sobel filters are applied to the reconstruction samples in the L-shape neighbouring region with thickness of 3 pixels. For boosting the coding gain, we proposed a two-stage filtering scheme to derive intra modes for coding. First stage is a pre-filtering stage of the reconstruction samples, filters like the bi-lateral filter or Gaussian filter are used to filter the reconstruction samples. In the second stage, there are multiple pairs of filters to derive the gradients (including amplitude and phase) of the neighbourhood. Assume P pre-filters are utilized, and Q pairs of filters are used for gradient calculation. Multiple intra modes (or multiple groups of intra modes) from these filters are available, the total combinations are P*Q. TM costs (or other kinds of cost evaluation, such as boundary matching) are calculated for sorting the P*Q combinations. The following strategies can be used to decide the final intra mode (or group of intra modes) derived from these P*Q combinations.
S.1 keep the one with lowest cost, no signalling
S.2 keep K combinations with lowest costs, signalling an index (0~K−1)

Any of the foregoing proposed methods can be applied to both DIMD luma and DIMD chroma derivation process.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

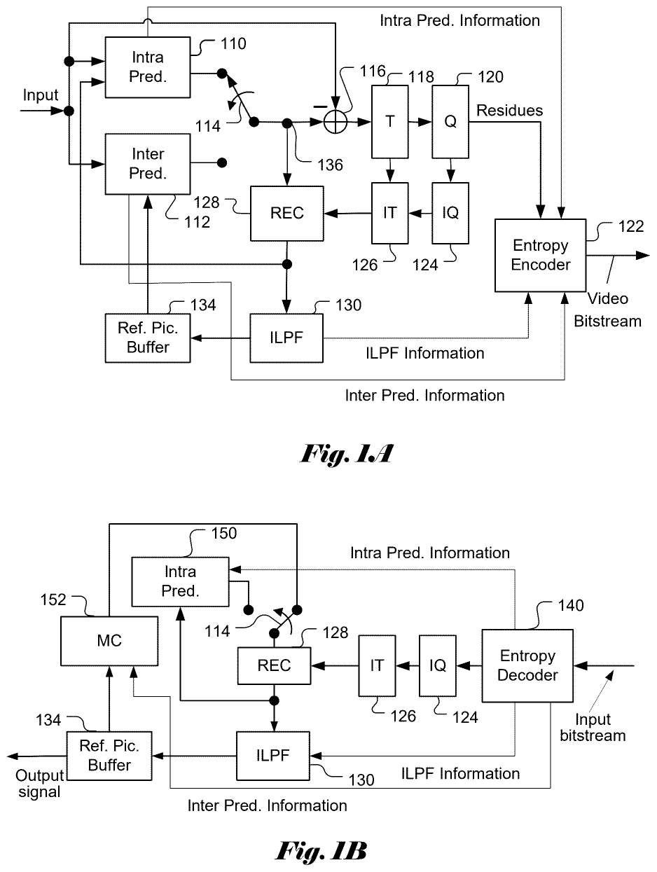

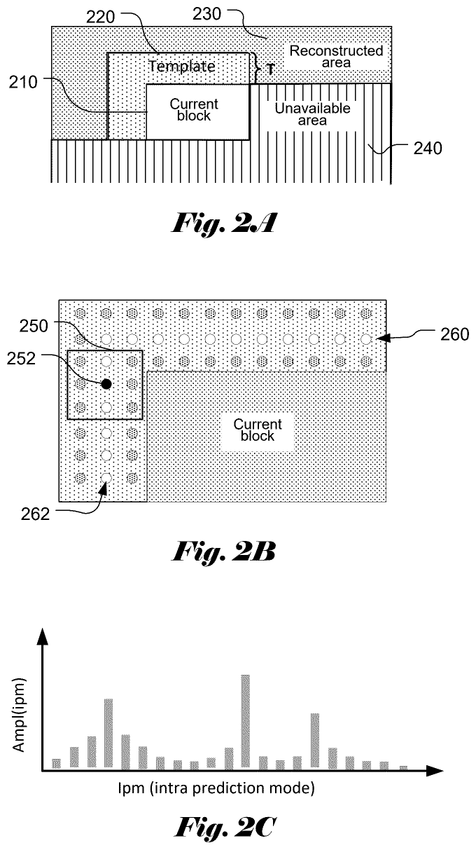

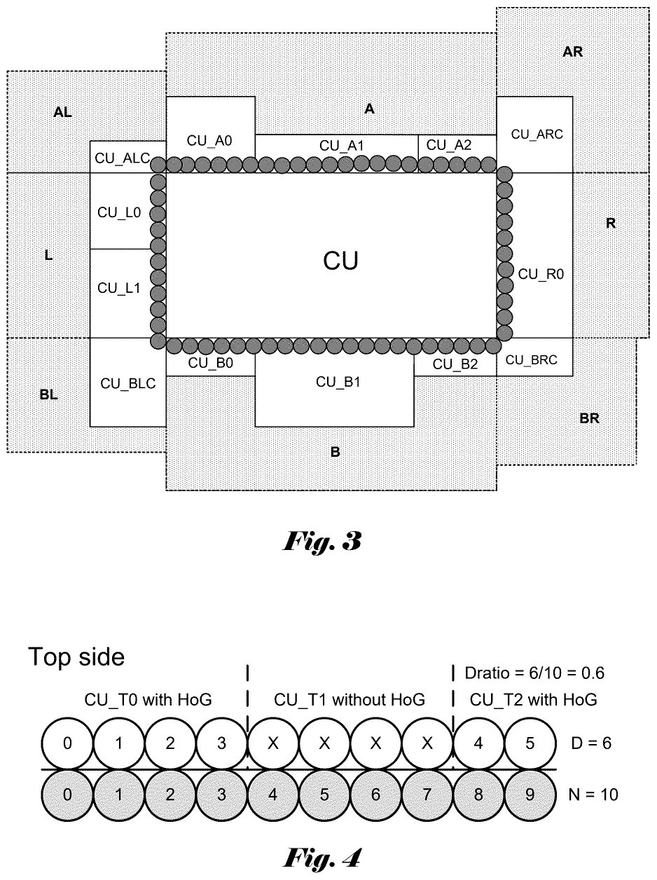

The HoG storage, inheritance and blending methods as described above can be implemented in an encoder side or a decoder side. For example, any of the proposed candidate derivation method can be implemented in an Intra coding module (e.g. Intra Pred. 150 in FIG. 1B) in a decoder or an Intra coding module is an encoder (e.g. Intra Pred. 110 in FIG. 1A). Any of the proposed method of HoG storage, inheritance and blending can also be implemented as a circuit coupled to the intra coding module at the decoder or the encoder. However, the decoder or encoder may also use additional processing unit to implement the required cross-component prediction processing. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

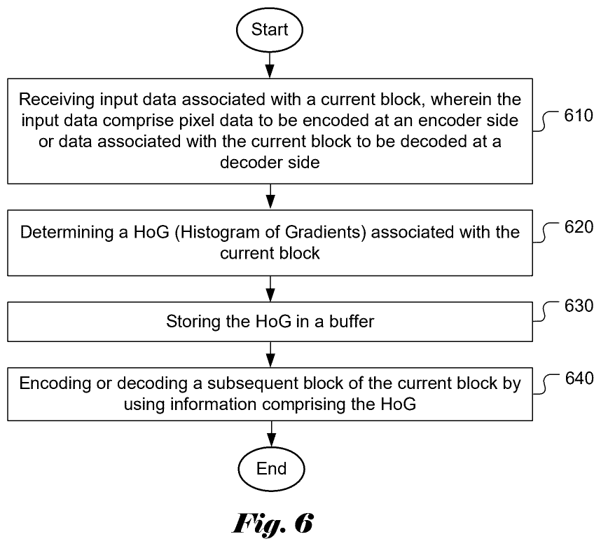

FIG. 6 illustrates a flowchart of an exemplary video coding system that stores the HoG of the current block for use by one or more subsequent blocks according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block is received in step 610, wherein the input data comprise pixel data to be encoded at an encoder side or data associated with the current block to be decoded at a decoder side. A HoG (Histogram of Gradients) associated with the current block is determined in step 620. The HoG is stored in a buffer in step 630. A subsequent block of the current block is encoded or decoded by using information comprising the HoG in step 640.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side;
determining a HoG (Histogram of Gradients) associated with the current block;
storing the HoG in a buffer; and
encoding or decoding a subsequent block of the current block by using information comprising the HoG.

2. The method of claim 1, wherein the current block is encoded or decoded using current information comprising stored one or more HoGs from one or more neighbouring regions of the current block.

3. The method of claim 2, wherein said one or more neighbouring regions of the current block comprise an above region, an above-left region, a left region, a bottom-left region, a bottom region, a bottom-right region, a right region, an above-right region, or a combination thereof.

4. The method of claim 1, wherein the HoG associated with the current block is available for the current block if the current block is DIMD (Decoder Side Intra Mode Derivation) coded, the current block is coded with one or more first angular modes overlapped with one or more second angular modes derived by the DIMD, or the current block is coded with DIMD inheritance mode.

5. The method of claim 1, wherein the HoG associated with the current block is inherited from one or more HoGs of one or more neighbouring regions.

6. The method of claim 5, wherein said one or more neighbouring regions correspond to one or more above blocks and one or more left blocks.

7. The method of claim 5, wherein bins of the HoG associated with the current block are derived by averaging corresponding bins of said one or more HoGs of said one or more neighbouring regions respectively.

8. The method of claim 5, wherein bins of the HoG associated with the current block are derived by using a weighted sum of corresponding bins of said one or more HoGs of said one or more neighbouring regions respectively, and wherein weights for the weighted sum of the corresponding bins of said one or more HoGs of said one or more neighbouring regions are related to confidence factors of said one or more neighbouring regions.

9. The method of claim 5, wherein a flag is signalled or parsed to indicated the HoG associated with the current block being inherited from said one or more HoGs of said one or more neighbouring regions.

10. The method of claim 1, wherein the HoG associated with the current block is inherited from one or more selected neighbouring regions.

11. The method of claim 10, wherein said one or more selected neighbouring regions are from above region and left region, from the above region, above-left region, the left region and bottom-left region, from the left region only, or from the above region only.

12. The method of claim 10, wherein one or more indexes are signalled or parsed to indicate said one or more selected neighbouring regions.

13. The method of claim 10, wherein said one or more selected neighbouring regions are determined implicitly by using template matching and/or boundary matching.

14. The method of claim 10, wherein validity check is applied to one or more neighbouring regions of the current block and an invalid neighbouring region is eliminated from said one or more selected neighbouring regions, and wherein the validity is determined according to a ratio a first number of boundary samples of the current block having HoG values and a second number of boundary samples of an adjacent neighbouring region.

15. The method of claim 1, wherein two or more predictors associated with two or more intra modes derived from two or more regions of said one or more neighbouring regions of the current block are blended to form a final predictor for the current block.

16. The method of claim 14, wherein said two or more predictors are blended using position-dependent weighting.

17. The method of claim 15, wherein the position-dependent weighting is determined for one or more positions of said one or more neighbouring regions of the current block according to a total number of samples coded with DIMD mode in said one or more positions of said one or more neighbouring regions of the current block.

18. The method of claim 17, wherein the position-dependent weighting is further dependent on sample position of the final predictor.

19. The method of claim 18, wherein the current block is divided into multiple bands and the position-dependent weighting is dependent on band location of the sample position of the final predictor.

20. The method of claim 14, wherein said two or more predictors are blended using position-independent weighting.

21. The method of claim 1, wherein when the current block is DIMD coded, a current HoG derived from the current block is blended with one or more HoGs from one or more neighbouring regions of the current block.

22. The method of claim 21, wherein the current HoG and said one or more HoGs from said one or more neighbouring regions of the current block are blended using equal weight for both or only for said one or more HoGs from said one or more neighbouring regions of the current block, the weight of the current HoG is the same as or different from the weights of said one or more HoGs from said one or more neighbouring regions of the current block.

23. The method of claim 21, wherein the current HoG and said one or more HoGs from said one or more neighbouring regions of the current block are blended using weights and wherein the weights are inversely proportional to distance between current block and said one or more neighbouring regions of the current block.

24. The method of claim 1, wherein the HoG associated with the current block is blended with one or more HoGs from one or more temporal regions.

25. The method of claim 24, wherein the HoG associated with the current block is blended with said one or more HoGs from said one or more temporal regions using POC (Picture Order Count) distance dependent weight.

26. An apparatus for video coding, the apparatus comprising one or more electronics or processors arranged to:
receive input data associated with a current block, wherein the input data comprise pixel data to be encoded at an encoder side or data associated with the current block to be decoded at a decoder side;
determine a HoG (Histogram of Gradients) associated with the current block;
store the HoG in a buffer; and
encode or decode a subsequent block of the current block by using information comprising the HoG.
